(19) United States
(12) Patent Application Publication
(10) Pub. No.: US 2020/0055115 A1
(43) Pub. Date: Feb. 20, 2020

(54) PRODUCTS INCORPORATING CARBON NANOMATERIALS AND METHODS OF MANUFACTURING THE SAME

(71) Applicant: Charles Harrison Benton CAUDILL, San Francisco, CA (US)

(72) Inventor: Charles Harrison Benton CAUDILL, San Francisco, CA (US)

(21) Appl. No.: 16/546,085

(22) Filed: Aug. 20, 2019

Related U.S. Application Data
(60) Provisional application No. 62/719,991, filed on Aug. 20, 2018.

(51) Int. Cl. B22F 1/00; B33Y 70/00; B22F 3/00; B22F 3/15; C01B 32/158; C01B 32/182; C01B 32/152; C01B 32/05; C04B 14/02; C08K 3/04

(52) U.S. Cl. CPC B22F 1/0003; C08K 2201/011; B22F 3/008; B22F 3/15; C01B 32/158; C01B 32/182; C01B 32/152; C01B 32/05; C04B 14/026; C08K 3/04; C08K 3/041; C08K 3/042; C08K 3/045; B22F 2302/40; B33Y 70/00

(57) ABSTRACT

Carbon nanotubes (CNTs), graphene platelets, or other forms of graphene are incorporated into raw materials before products and product components are manufactured from the materials. For example, CNTs may be incorporated into metallic powders, which can be pressed and sintered into metallic products and product components. CNTs or graphene platelets can also be incorporated into plastics, ceramics, metals, or other materials used to construct products and product components by additive manufacturing. When incorporated into the products and product components, the CNTs or graphene platelets can improve various properties of the products and product components, such as thermal conductivity, electrical conductivity, or structural properties.

### RELATED APPLICATION(S)

The present application claims priority to U.S. Provisional Pat. Appl. No. 62/719,991, filed Aug. 20, 2018, incorporated herein by reference in its entirety.

### FIELD OF THE INVENTION

The present invention generally relates to products incorporating carbon nanomaterials such as nanotubes, graphene platelets, and other forms of graphene therein, and to methods of manufacturing such products.

### DISCUSSION OF THE BACKGROUND

Product manufacturers often must balance desired material properties of their products against cost and manufacturability. These desired material properties, including, for example, thermal or electrical conductivity or mechanical properties such as tensile strength, elastic modulus, or brittleness, can often be tailored by selecting particular materials that exhibit the desired property. However, the material that exhibits one desired property may not satisfy other design requirements for a product. For example, a material such as copper has a high thermal conductivity, but also a high density. This density may prohibit the use of copper in weight-sensitive products, such as components of a satellite or aircraft. The material with properties satisfying design requirements may also be prohibitively expensive, or may not exist.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

Embodiments of the present invention relate to methods for making composite products and components using carbon nanomaterials. The method generally comprises (1) mixing carbon nanomaterials into a liquid matrix or a matrix curable by a physical process to generate a graphene-based material; and (2) manufacturing a product or product component using the graphene-based material. The carbon nanomaterials may comprise carbon nanotubes, graphene platelets, one or more fullerenes, or linear acetylenic carbon.

In various embodiments, the method comprises mixing the carbon nanotubes into the matrix curable by the physical process; incorporating the carbon nanotubes into the liquid matrix; mixing the graphene platelets into the matrix curable by the physical process; or incorporating the graphene platelets into the liquid matrix. The matrix curable by the physical process may comprise a metal powder, and the liquid matrix may comprise a ceramic or a polymer. The method may further comprise aligning the carbon nanotubes before manufacturing the product or product component.

When the method comprises mixing the carbon nanotubes into the matrix curable by the physical process, the matrix may comprise a metallic powder, and manufacturing the product or product component may comprise pressing and sintering the graphene-based material. The method may further comprise aligning the carbon nanotubes before sintering the graphene-based material. Alternatively, manufacturing the product or product component may comprise additive manufacturing (e.g., printing).

When the method comprises incorporating the carbon nanotubes into the liquid matrix, manufacturing the product may comprise at least one of extruding the product or product component from the graphene-based material, or printing the product or product component.

When the method comprises incorporating the graphene platelets into the matrix curable by the physical process, the matrix may comprise a metallic powder, and manufacturing the product or product component may comprise pressing and sintering the graphene-based material. Alternatively, manufacturing the product or product component may comprise additive manufacturing (e.g., printing).

When the method comprises incorporating the graphene platelets into the liquid matrix, manufacturing the product or product component may comprise at least one of extruding the product or product component from the graphene-based material, or printing the product or product component.

A further aspect of the present invention relates to a product or product component, comprising carbon nanomaterials in a matrix. The carbon nanomaterials in the matrix have at least one improved physical property selected from (i) a thermal conductivity that is at least 10%, or any other minimum value that is greater than 10%, greater than that of the matrix without the carbon nanomaterials; (ii) an electrical conductivity that is at least 10%, or any other minimum value that is greater than 10%, greater than that of the matrix without the carbon nanomaterials; (iii) a tensile strength that is at least 50%, or any other minimum value that is greater than 50%, greater than that of the matrix without the carbon nanomaterials; and (iv) at least 25%, or any other minimum value that is more than 25%, less matrix material (e.g., by weight) than that of the matrix without the carbon nanomaterials and that provides equivalent (e.g., the same or greater) performance and/or functionality.

When the improved physical property of the product or product component is the thermal conductivity, the electrical conductivity or the tensile strength, the amount of the matrix material may be less than that of the matrix without the carbon nanomaterials. When the improved physical property is the thermal conductivity, the electrical conductivity or the amount of the matrix material, the tensile strength may be identical to or greater than that of the matrix without the carbon nanomaterials. When the improved physical property is the thermal conductivity, the tensile strength or the amount of the matrix material, the electrical conductivity may be identical to or greater than that of the matrix without the carbon nanomaterials. When the improved physical property is the electrical conductivity, the tensile strength or the amount of the matrix material, the thermal conductivity may be identical to or greater than that of the matrix without the carbon nanomaterials.

As for the present method, the carbon nanomaterials in the product or product component may comprise carbon nanotubes, graphene platelets, one or more fullerenes, or linear acetylenic carbon. Alternatively or additionally, the matrix may comprise one or more metals, polymers, or ceramics.

The present invention advantageously provides improved physical, thermal and/or electrical properties relative to the matrix material in the absence of the carbon nanomaterials. These and other advantages of the present invention will become readily apparent from the detailed description of various embodiments below.

### BRIEF DESCRIPTION OF THE DRAWINGS

FIG. 1 is a flowchart illustrating a first example method for manufacturing a product using a graphene-based material in accordance with the present invention.

FIG. 2 is a flowchart illustrating another example method for manufacturing a product using a graphene-based material in accordance with the present invention.

FIG. 3 shows an example frying pan manufactured using a graphene-based material in accordance with the present invention.

FIG. 4 shows a diagram of an exemplary pressing and sintering process.

FIG. 5 shows a diagram of an example of metal injection molding (MIM) and equipment for the same.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

The present invention can include various allotropic forms of thermally conductive carbon with bonds that include π orbitals or other form(s) of delocalization (hereinafter, “carbon nanomaterials”). The carbon allotropes that are particularly suitable for the present invention have favorable mechanical, electrical, and thermal properties, such as high electrical and thermal conductivity, or high tensile strength. For example, in addition to CNTs and graphene, the invention may include fullerenes (e.g., C₆₀, C₇₀) and linear acetylenic carbon (LAC). However, the invention does not include graphite or amorphous carbon, which generally have insufficient thermal conductivity and/or mechanical strength to provide the desired properties.

The term “physical process” herein may refer to any process that results in plastic deformation of a material or product. For example, physical processes may include pressing (including radiation pressure), sintering, extrusion, molding, printing, melting, cooling, evaporating, magnetic induction, application of ultrasound, combinations thereof, etc.

A “liquid matrix” is a matrix or support for another material (in this case, for carbon nanomaterials) that is in liquid form during processing temperatures. Exemplary liquid matrices include polymers (e.g., thermoplastic polymers) and ceramic precursors. For example, a “liquid matrix” may be formed during processing, such as by melting a polymer matrix that is solid at ambient temperature (e.g., 20-25° C.), dissolving a solid-phase polymer or ceramic matrix in a solvent, or using one or more liquid-phase polymer or ceramic precursors, which then is/are converted after processing to a matrix that is in the solid phase at room temperature. Thermoplastic polymers that can be melted or dissolved in an organic solvent to form a liquid matrix include polyethylene, polypropylene, polyvinyl alcohol, and copolymers, mixtures and blends thereof, etc. Ceramic precursors such as tetraethyl orthosilicate and other alkoxy- and/or alkylaminosilanes, as well as aluminum- and/or other metal-containing alkoxide and alkylamide precursors.

For the sake of convenience and simplicity, the terms “product,” “product component,” and grammatical variations thereof are generally used interchangeably herein, but are generally given their art-recognized meanings. In some cases, the same object (e.g., a heat exchanger) can be both a product and a product component.

The invention, in its various aspects, will be explained in greater detail below with regard to exemplary embodiments.

An Exemplary Method of Making Products and Product Components Incorporating Carbon Nanomaterials Therein

In one aspect, the present invention relates to a method of making products and product components incorporating carbon nanomaterials therein, comprising (a) mixing the carbon nanomaterials into a liquid matrix or a matrix curable by a physical process to generate a graphene-based material, and (b) manufacturing the product or product component using the graphene-based material. One fundamental process comprises forming an uncured composite by mixing a matrix material (e.g., metal powder, polymer or polymer precursor, or ceramic powder or precursor) with a carbon nanomaterial (e.g., carbon nanotubes and/or graphene platelets), forming, molding, printing or extruding the uncured composite (e.g., in a predetermined size/area and/or into a predetermined shape), then curing the composite by a physical process (e.g., heating, pressing, etc.).

Carbon nanotubes (CNTs), graphene platelets, or other forms of graphene or allotropes of carbon having delocalized π bonds are incorporated into raw materials before products or product components are manufactured from the materials. For example, CNTs are incorporated into metallic powders, which can be pressed and sintered into metallic products. CNTs or graphene platelets can also be incorporated into plastics, ceramics, metals, or other materials used to construct products by additive manufacturing. Carbon nanomaterials can also be mixed with ceramic powders, then pressed and/or sintered similarly to metal powders to make ceramic products and product components. When incorporated into the products or components, the CNTs or graphene platelets can improve various properties of the product, such as thermal conductivity, electrical conductivity, or mechanical or structural properties.

Materials that incorporate CNTs, graphene platelets, or other forms of graphene are referred to herein generally as “graphene-based materials.” In general, graphene-based materials comprise a matrix of a non-graphene material, such as a metal, polymer, or ceramic. The CNTs, graphene platelets, or other form of graphene are incorporated into the matrix before a product is manufactured from the resulting graphene-based material. The process to incorporate the graphene into the matrix can vary depending on the type of material used for the matrix, the manufacturing process to be used for the product, and the desired thermal, electrical, or structural properties of the product. For example, because carbon nanotubes can be degraded by temperatures that are high enough to melt many metals, CNTs may be incorporated into metallic products at a solid phase of the metal. If the matrix is instead a ceramic or polymer with a lower melting point, the CNTs can be incorporated into the matrix while the matrix is in a liquid phase.

Mixing CNTs, graphene platelets, or other forms of graphene into a matrix gives a product manufacturer more freedom to tailor the material properties of their products. For example, the matrix material can be chosen based on cost as well as weight, susceptibility to corrosion or other wear, biocompatibility, regulatory compliance, or other restrictions. The properties of the matrix material can then be modified with the CNTs or graphene platelets to achieve other design goals for the product. For example, CNTs may increase the corrosion susceptibility and/or may result in galvanic corrosion of a metal matrix. However, CNTs do not impact other matrices, such as plastics.

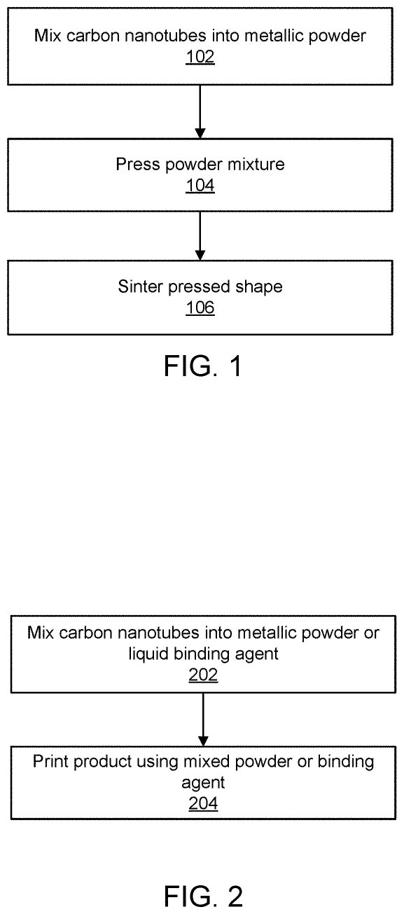

FIG. 1 is a flowchart illustrating a first example method for manufacturing a product using a graphene-based material. Although FIG. 1 describes using carbon nanotubes for the manufacturing process, graphene platelets, fullerenes, or other forms of graphene may be used instead of or in addition to CNTs in the process.

As shown in FIG. 1, carbon nanotubes are mixed 102 into a metallic powder. The CNTs and metallic powder can be mixed 102 by any suitable mechanical mixing procedure. For example, any standard mechanical mixing process may be used that provides a predetermined and/or desired variability (or uniformity) in carbon density. The metallic powder may be made or generated by milling or by spraying high-pressure water through molten metal. A ratio between CNTs and metal particles in the mixture can be adjusted to achieve desired material properties of the product to be manufactured from the mixture. A binding agent can also be mixed 102 with the metallic powder and CNTs. In some cases, the CNTs and metallic powder can be mixed first and the binding agent added to the mixture. In other cases, the CNTs can be first mixed with the binding agent before the CNT/binding agent mixture is mixed with the metallic powder.

The mixture of CNTs, metallic powder, and (if used) binding agent is pressed 104 into a desired shape for a product and sintered 106 at a temperature below the melting point of the metallic powder. In some cases, if alignment of the CNTs would help achieve the desired material properties of the product, an alignment process can be performed before sintering 106 the product. In other cases, where a randomized distribution of the CNTs achieves the desired material properties, no alignment process is performed.

Conditions for pressing and sintering the metal powder matrix with carbon nanomaterials include conventional and/or standard powder metallurgy processes. An example of equipment that can be used is a home or garage hydraulic press, using a steel plate with a cylinder drilled into it. The metal powder matrix is placed with the carbon nanomaterials into the cylinder, and the hydraulic press applies pressure to the powder. A simple home sintering furnace is capable of reaching the temperatures necessary to mechanically deform the compressed powder and/or achieve the desired property or properties.

The pressure range, temperature range, and length of time for pressing and/or sintering is dependent upon the matrix material, the carbon nanomaterial, the complexity and/or purpose (e.g., of the product or component), etc. For example, typical pressures range from 80 psi to 1000 psi (0.5 MPa to 7 MPa), although pressures in the range of from 1000 psi to 1,000,000 psi (7 MPa to 7000 MPa) can be used. Pressures of from 10 tons/in² to 50 tons/in² (150 MPa to 700 MPa) may be used for metal powder compaction. Temperatures ranging from 200° C. to 1500° C. (e.g., 480° C. to 1230° C.) can be used for pressing and/or sintering. The pressed or compacted metal powder and carbon nanomaterial may be heated in an inert gas (e.g., argon, nitrogen, etc.). The length of time is typically a length of time that provides or is necessary to achieve a predetermined or desired physical property.

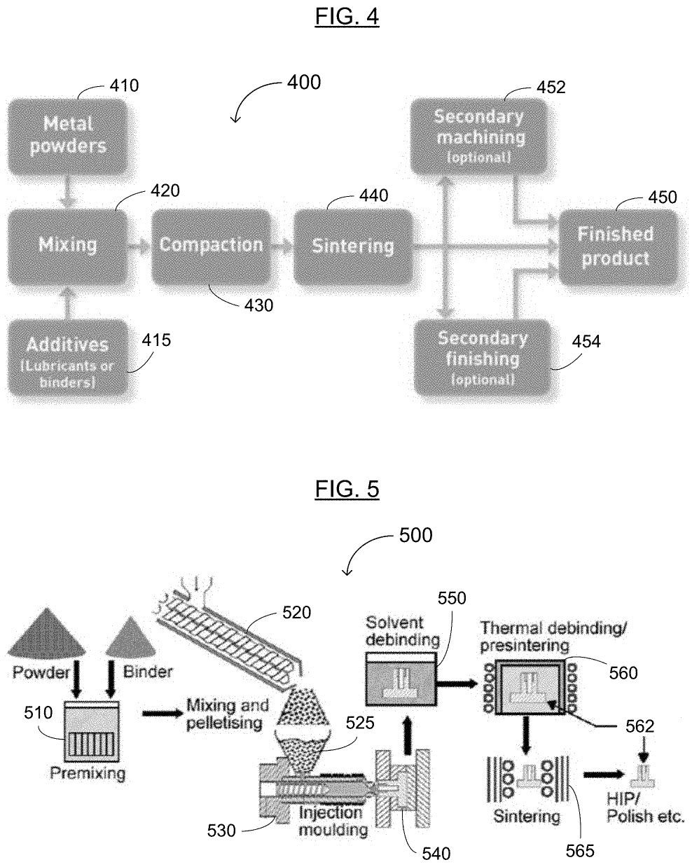

FIG. 4 shows a diagram of an exemplary pressing and sintering process 400. One or more metal powders are prepared (e.g., milled, sorted, weighed, combined, etc.) at 410. In parallel, a graphene nanomaterial (or precursor thereof that yields a graphene nanomaterial during processing) and one or more additives (e.g., lubricants or binders) are prepared (e.g., weighed, combined, purified, etc.) at 415. The metal powder(s), the graphene nanomaterial (or precursor thereof) and the additive(s) are mixed in a conventional mixer at 420. The mixed metal powder(s) and additive(s) are compacted (e.g., pressed) at 430 in a conventional press, compressor or compactor. The compacted or compressed metal powder(s) and additive(s) are then sintered (e.g., heated) in a conventional oven or furnace at 440. The additive(s), which typically comprise organic (i.e., carbon-based) materials, generally burn off during sintering. Any graphene nanomaterial precursor is converted at least in part to a graphene nanomaterial by the end of the sintering process at 440. In some cases, sintering produces the final product at 450. Optionally, the sintered metal powder may be conventionally machined (e.g., drilled, lathed, laser cut, etc.) at 452 and/or conventionally finished (e.g., polished, coated, painted, etc. 0 at 454.

In a more specific example, aluminum may be sintered (e.g., in the process 400 in FIG. 4) at 600-620° C. in a nitrogen atmosphere (i.e., where the air is replaced with 100% nitrogen). This temperature is well below the denaturing temperature of CNTs, especially in an oxygen-free environment. While the melting point of elemental aluminum is about 660° C., the smelting temperature is often about 1000° C. in uncontrolled atmosphere. This temperature is well above the denaturing temperature of CNTs. This method of sintering aluminum provides all of the standard advantages normally associated with pressing and sintering, but also with the benefit of enabling incorporation of CNTs without any additional processing steps.

In addition, iron/aluminum alloys may be pressed (e.g., in the process 400 in FIG. 4) at 400-500 MPa (e.g., 450 MPa) and at 450-600° C. (e.g., 500° C.), followed by sintering for about 30-120 minutes (e.g., 1 hour) at 750-900° C. (e.g., 800° C.). This method produces an ingot that can be machined by conventional processes, or a more complicated part, such as an RF shield for a radio system. Such an RF shield may also function as a thermal transport and/or control device, as it can carrying excess heat away from one or more RF power amplifiers or other devices in the radio system that can attain an operational temperature too high or too low to maintain optimal functionality.

The proportion of carbon nanomaterials to metal powder can be from 1% to 75% (e.g., by weight or by volume). For example, the proportion of carbon nanomaterials to metal powder may be from 2% to 60% by weight.

Another Exemplary Method

FIG. 2 is a flowchart illustrating another example method for manufacturing a product using a graphene-based material. As in FIG. 1, FIG. 2 describes using carbon nanotubes for the manufacturing process, but graphene platelets or other forms of graphene may be used instead of or in addition to CNTs in the process.

As shown in FIG. 2, carbon nanotubes are mixed into a metallic powder or a liquid binding agent, or both. The binding agent may be a wax conventionally used in metal injection molding. Any suitable mechanical mixing procedure can be used, and a ratio of the CNTs to metal particles or binding agent can be adjusted to achieve desired material properties of the product to be manufactured from the mixture.

A product is printed 204 using the metallic powder, CNTs, and liquid binding agent. Any conventional three-dimensional printing process can be used to print 204 the product using the graphene-based material. For example, the metallic powder can be deposited or rolled out in thin layers that are bound together by the binding agent ejected from a print head. Alternatively, a metal powder mixed with CNTs can be fused into a desired shape by laser sintering or electron beam melting.

Instead of incorporating the CNTs into metallic items, a similar process to that shown in FIG. 2 can be used to 3D print polymer-based products. For example, CNTs can be mixed into a liquid polymer substrate that can be deposited in thin layers by a print head.

Yet another manufacturing process for graphene-based products incorporates CNTs or graphene platelets into a liquid polymer or ceramic prior to molding, extrusion, or casting of the graphene-based liquid polymer or ceramic into a product. As used herein, the term “molding” covers a variety of different processes (e.g., injection molding, blow molding, compression molding, metal injection molding, etc.). Molding can be used to form products or components from thermoplastic polymers, ceramics, and metals, among other matrix materials. For example, if the product or component has a complex geometry, a relatively low tensile or mechanical strength, and a relatively low density, then metal injection molding may be an appropriate technique.

Extrusion and casting processes useful in the present invention are not limited, but additive manufacturing, metal injection molding, and powder forging may be commercially useful extrusion and casting processes. The conditions (e.g., time, temperature, rate, viscosity, etc.) for such extrusion and casting processes suitable for the present invention are similar or identical to those used conventionally for the matrix materials.

FIG. 5 shows a diagram of an example 500 of metal injection molding (MIM) and equipment for the same. Metal powder(s), binder(s), and CNTs (for example) can be placed in a pre-mixer at 510, which mechanically mixes the metal powder(s), binder(s), and CNTs. After further mixing/heating in a conventional screw mixer at 520, the metal powder(s), binder(s), and CNTs are formed into workable pellets in a conventional pelletizer at 525. The pellets are then introduced into an injector at 530, where they may be further heated (e.g., into a deformable or fluid-like state). The injector then forces the heated and deformable metal powder and CNT mixture into a mold at 540. After chemical and/or physical removal of the binder(s) by solvent treatment at 550 and/or thermal treatment (e.g., pre-sintering, or burn off) at 560, the green (i.e., unsintered) part in the mold 562 may then be sintered at 565 before other finishing steps (e.g., polishing) at 570. During sintering, the part may shrink by 15-20% as the porosity decreases.

Whereas the example for pressing and sintering set forth in FIG. 4 may produce a simpler shape, MIM is often the appropriate choice for a more complicated piece, or where higher performance is warranted or desired. Components made by MIM are often less porous than the same components made by pressing and sintering. In some cases, the geometry of the desired product (e.g., interconnected but freely-moving parts) may make render conventional machining infeasible or impractical.

Components and/or parts made according to the present invention may be particularly advantageous for defense and/or law enforcement equipment. For example, the B2 Spirit Bomber specifies or solicits components that approach or ensure thermal equilibrium to decrease the odds of detection with thermal sensors. Complex structural components manufactured according to the present invention may exhibit improved thermal conductivity and an improved ability to remain undetected.

Exemplary Products Incorporating Graphene Therein

A further aspect of the invention relates to a product, comprising carbon nanomaterials in a matrix. The carbon nanomaterials in the matrix have at least one physical property selected from (a) a thermal conductivity that is at least 10% (e.g., at least 50%, or any other minimum value that is greater than 10%, such as 2× or more) greater than that of the matrix without the carbon nanomaterials, (b) a tensile strength that is at least 50% greater (e.g., 2× or more) than that of the matrix without the carbon nanomaterials; (c) an electrical conductivity that is at least 10% (e.g., at least 25%, or any other minimum value that is greater than 10%, such as 1.5× or more) greater than that of the matrix without the carbon nanomaterials, or (c) at least 25% less matrix material by weight than that of the matrix without the carbon nanomaterials and that provides equivalent (e.g., the same or greater) performance and/or functionality (e.g., one or more physical properties that are the same or better). The product may be or comprise the carbon-impregnated material resulting from any of the present methods, or a subsequently developed products including or made from one or more of the carbon-impregnated materials.

A distinguishing structural feature and/or characteristic of the present products is the incorporation of the carbon nanomaterials into other materials (i.e., the matrix). For example, it is known to grow graphene on a surface (e.g., in the formation of a graphene FET), or to use relatively homogenous materials manufactured from carbon nanotubes. However, the present products are designed such that the graphene or CNTs are part of a heterogeneous material. For example, a heat-pipe according to the present invention may include a combination of an aluminum structural piece and a customized, carbon nanomaterial-containing additional component.

One example or type of product manufactured using graphene-based materials is cookware, such as frying pans or pots. Cookware manufacturers typically design their products to have excellent thermal conductivity, but the cost of conductive materials such as copper can be high.

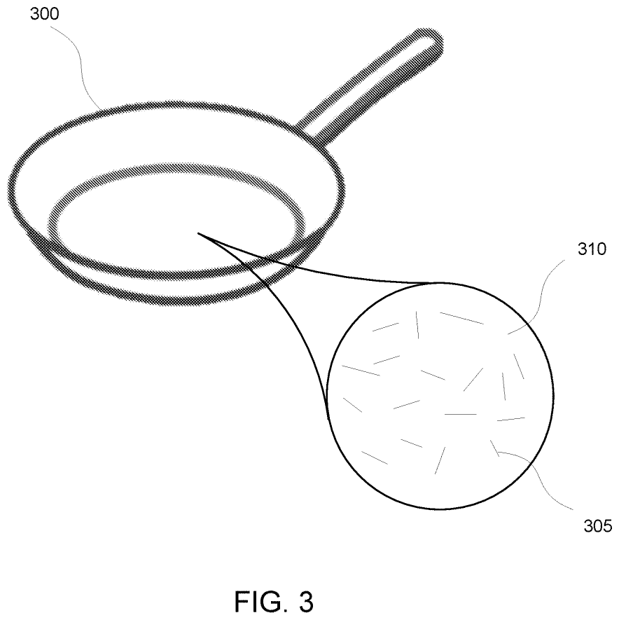

FIG. 3 shows an example frying pan 300 manufactured using a graphene-based material. As shown, the graphene-based material includes CNTs or graphene platelets 305 distributed randomly through a matrix 310 of aluminum, copper, magnesium, steel, or other metal or metal alloy. The matrix 310 material can be selected based on properties such as material cost, cost to manufacture the frying pan 300, ease of manufacture, or weight. For example, in addition to being low-cost, an aluminum matrix is relatively lightweight, which can make the pan easier for a consumer to use it. The CNTs or graphene platelets 305 when incorporated into the aluminum matrix improve the overall thermal conductivity of the material.

The frying pan 300 can be manufactured such that the CNTs or graphene platelets 305 are distributed at random angles in three-dimensional space. Because graphene has high thermal conductivity in its molecular plane and low thermal conductivity in a direction perpendicular to its molecular plane, graphene platelets conduct heat well in a planar direction and do not conduct heat well across their planes. Similarly, CNTs conduct heat well along their length, but do not conduct heat well perpendicularly to the tubes. Distributing the CNTs or platelets at random angles in the material therefore provides more uniform heat distribution throughout the frying pan 300.

The graphene-based material can be used to construct any portion of the frying pan 300. In some embodiments, an entire body of the frying pan 300 (i.e., excluding at least part of a handle) can be manufactured out of the graphene-based material. In another embodiment, a thermal core of the frying pan 300 is manufactured using the graphene-based material, while other portions of the pan are constructed from other materials (such as aluminum). For example, the thermal core is manufactured using a copper matrix with CNTs or graphene platelets distributed throughout. As used herein, a “thermal core” refers to a thermally conductive material that, in the absence of a cladding or outer coating encasing the thermal core, could be at risk of galvanic corrosion. Thus, for example, stainless steel may be utilized as a cladding on the thermal core to prevent its corrosion. Examples of other cookware that can incorporate the present invention include pails (e.g., for ice cream turning), saucepans, baking dishes, lobster pots, and mixing bowls.

Another example product that can be manufactured using graphene-based materials is a satellite or a component of a satellite. Satellites may have various structural or functional components that may benefit from precisely-tailored thermal conductivity, thermal expansion, electrical conductivity, tensile strength, ductility, or other properties. The overall weight of a satellite is typically a critical factor in its design. Accordingly, a satellite manufacturer can use a graphene-based material to construct various components of the satellite with tailored mechanical or electrical properties, without significantly increasing the satellite's weight. The present invention can build standard components using standard machining techniques (as opposed to systems designed to build components for a dedicated purpose), which allows for manufacturing satellite components with better thermal characteristics as a whole, with little or no impact on the manufacturing process. Similarly, components of aircraft can be manufactured from a graphene-based material to reduce weight while achieving tailored properties. Examples of components of satellites, spacecraft and aircraft that can be made using the present invention include the main chassis, a heat pipe, an RF shield, or any other structural component (e.g., that can be used to distribute and/or dissipate heat).

Yet another example product is a thermal imaging system. The term “thermal imaging system” as used herein may refer to an imaging system that operates in the infrared part of the spectrum, where the sensor(s) is typically actively cooled. Thermal imaging systems typically must remain cool in order to accurately measure temperature of other objects. As the temperature of components of a thermal imaging system increase, the measurement accuracy of the system often decreases. Some thermal imaging systems use heat pipes with high thermal conductivity to transfer heat away from critical imaging components. These heat pipes can be manufactured using a graphene-based material, to further increase the thermal conductivity of the pipe. Other components of thermal imaging systems can be similarly produced using a graphene-based material to transfer heat away from critical imaging components. Other imaging products (such as projectors) in which high temperatures are produced can use products and/or components incorporating the present invention to aid in thermal dissipation. Similarly, heat pipes for laptop computers are often made of copper, but using the present invention, such heat pipes can be made for a lower cost, at a lower weight, and optionally with higher performance, from aluminum and a carbon nanomaterial than from copper.

Cryogenic pumps are still another example product that may be manufactured using a graphene-based material. In use, a cryogenic pump traps a vapor or gas that is passed over and condenses upon cooled surfaces within the cryopump. These surfaces can be manufactured using a graphene-based material with higher thermal conductivity than conventional materials, reducing an amount of energy needed to maintain a sufficiently cold temperature. The cryopump, or portions of a cryopump, can be manufactured according to any of the methods described above. For example, a cryopump can be 3D printed using a graphene-based substrate.

Electrical wires can be manufactured by aligning carbon nanotubes in a graphene-based material. For example, a plastic mixed with carbon nanotubes can be employed as a graphene-based material in a 3D printing process. As each layer of the material is deposited, an electrical or magnetic field can be applied to the product to orient and align the newly-deposited CNTs. The result of the printing process is a plastic wire capable of conducting electricity in the direction of the CNT orientation. Aluminum wires can also be manufactured with higher electrical conductivity than wires made from aluminum alone by aligning carbon nanotubes incorporated into the aluminum. Such wires may also have higher tensile strength than wires made from aluminum alone. This would allow power companies to make smaller wires with smaller towers, less power loss, less produced ozone,

Other products may include blast deflectors for aircraft carriers, and components of space systems that are thermally sensitive. In space systems, it is important both to spread the concentrated heat (from perhaps a power amplifier in an RF system, a payload, or a processor) so that local temperatures do not exceed tolerances, and to effectively radiate or dissipate that heat.

### CONCLUSION/SUMMARY

From the foregoing, it will be appreciated that specific embodiments of the invention have been described herein for purposes of illustration, but that various modifications may be made without deviating from the scope of the invention. Accordingly, the invention is not limited except as by the appended claims.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method comprising:
mixing carbon nanomaterials into a liquid matrix or a matrix curable by a physical process to generate a graphene-based material; and
manufacturing a product or product component using the graphene-based material.

2. The method of claim 1, wherein the carbon nanomaterials comprise carbon nanotubes, graphene platelets, one or more fullerenes, or linear acetylenic carbon.

3. The method of claim 2, comprising mixing the carbon nanotubes into the matrix curable by the physical process.

4. The method of claim 3, wherein the matrix comprises a metallic powder, and wherein manufacturing the product or the product component using the graphene-based material comprises pressing and sintering the graphene-based material.

5. The method of claim 4, further comprising aligning the carbon nanotubes before sintering.

6. The method of claim 3, wherein the matrix comprises a metallic powder, and wherein manufacturing the product or the product component using the graphene-based material comprises additive manufacturing.

7. The method of claim 6, wherein the additive manufacturing comprises printing.

8. The method of claim 2, comprising incorporating the carbon nanotubes into the liquid matrix.

9. The method of claim 8, wherein manufacturing the product or product component comprises at least one of:
extruding the product or the product component from the graphene-based material, or
printing the product or the product component.

10. The method of claim 9, wherein the liquid matrix comprises a ceramic or a polymer.

11. The method of claim 9, further comprising aligning the carbon nanotubes prior to manufacturing the product or the product component.

12. The method of claim 2, comprising mixing the graphene platelets into the matrix curable by the physical process.

13. The method of claim 12, wherein the matrix comprises a metallic powder, and wherein manufacturing the product or the product component using the graphene-based material comprises pressing and sintering the graphene-based material.

14. The method of claim 12, wherein the matrix comprises a metallic powder, and wherein manufacturing the product or the product component using the graphene-based material comprises additive manufacturing.

15. The method of claim 2, comprising incorporating the graphene platelets into the liquid matrix.

16. The method of claim 15, wherein manufacturing the product or the product component comprises at least one of:
extruding the product or the product component from the graphene-based material, or
printing the product or the product component.

17. The method of claim 16, wherein the liquid matrix comprises a ceramic or a polymer.

18. A product or product component, comprising carbon nanomaterials in a matrix, wherein:
a) the carbon nanomaterials in the matrix have at least one physical property selected from:
i) a thermal conductivity that is at least 10% greater than that of the matrix without the carbon nanomaterials;
ii) an electrical conductivity that is at least 10% greater than that of the matrix without the carbon nanomaterials;
iii) a tensile strength that is at least 50% greater than that of the matrix without the carbon nanomaterials; and
iv) at least 25% less matrix material than that of the matrix without the carbon nanomaterials and that provides equivalent performance and/or functionality; and
b) when the physical property is:
i) the thermal conductivity, the electrical conductivity or the tensile strength, then an amount of the matrix material is less than that of the matrix without the carbon nanomaterials;
ii) the thermal conductivity, the electrical conductivity or the amount of the matrix material, then the tensile strength is identical to or greater than that of the matrix without the carbon nanomaterials;
iii) the thermal conductivity, the tensile strength or the amount of the matrix material, then the electrical conductivity is identical to or greater than that of the matrix without the carbon nanomaterials; or
iv) the electrical conductivity, the tensile strength or the amount of the matrix material, then the thermal conductivity is identical to or greater than that of the matrix without the carbon nanomaterials.

19. The product or the product component of claim 18, wherein the carbon nanomaterials comprise carbon nanotubes, graphene platelets, one or more fullerenes, or linear acetylenic carbon.

20. The product or the product component of claim 18, wherein the matrix comprises a metallic powder.
